(19) United States
(12) Patent Application Publication
(10) Pub. No.: US 2013/0009920 A1
(43) Pub. Date: Jan. 10, 2013

(54) IMAGE DISPLAY METHOD AND APPARATUS

(75) Inventor: Hyun Woo SIM, Suwon-si (KR)

(73) Assignee: SAMSUNG ELECTRONICS CO. LTD., Suwon-si (KR)

(21) Appl. No.: 13/479,661

(22) Filed: May 24, 2012

(30) Foreign Application Priority Data
Jul. 4, 2011 (KR) 10-2011-0065982

(51) Int. Cl. G09G 5/00

(52) U.S. Cl. 345/204

(57) ABSTRACT

A method and an apparatus for displaying an image that is capable of reducing power consumption of a display apparatus are provided. The method includes identifying a priority of an image from a database to set a clock frequency of the image, adjusting a currently set clock frequency to a clock frequency matched to the identified priority, and displaying the image at the adjusted clock frequency.

### PRIORITY

This application claims the benefit under 35 U.S.C. §119(a) of a Korean patent application filed on Jul. 4, 2011 in the Korean Intellectual Property Office and assigned Serial No. 10-2011-0065982, the entire disclosure of which is hereby incorporated by reference.

### BACKGROUND OF THE INVENTION

1. Field of the Invention

The present invention relates to a method and an apparatus for displaying an image. More particularly, the present invention relates to a method and an apparatus for displaying an image capable of reducing power consumption of a display apparatus.

2. Description of the Related Art

Due to a growing interest in a display device, a high resolution display is implemented in areas such as mobile devices and TeleVisions (TVs). In order to output a high resolution image without compromising a refresh rate, a display driver chip such as a Liquid Crystal Display (LCD) display Integrated Circuit (IC) (LDI) outputs data at a high speed, thereby increasing current consumption of the display driver chip.

However, the high resolution display is not required in all circumstances. While high resolution is desirable when a user views a video or a particular image on a mobile device or TV, high resolution is not required for many other applications. For example, when the user views a menu of the mobile device or sends a text message, a low clock frequency can be used to drive the display device as long it is done such that as a human eye cannot detect a difference.

### SUMMARY OF THE INVENTION

Aspects of the present invention are to address at least the above-mentioned problems and/or disadvantages and to provide at least the advantages described below. Accordingly, an aspect of the present invention is to provide a method and an apparatus for displaying an image in which images are assigned priorities depending on user attention and a clock frequency is adjusted according to the priority of the image so that power consumption of a display apparatus and a load on a Central Processing Unit (CPU) as well as heat generation can be reduced.

According to an aspect of the present invention, an image display method is provided. The method includes identifying a priority of an image from a database to set a clock frequency of the image, adjusting a currently set clock frequency to a clock frequency matched to the identified priority, and displaying the image at the adjusted clock frequency.

According to another aspect of the present invention, an image display apparatus is provided. The method includes a clock generation unit for generating a clock signal, a display unit for displaying an image by using the clock signal received from the clock generation unit, a storage unit for storing a priority set to each image and different clock frequencies matched to each priority, and a controller for, when the image is changed, identifying a priority of a changed image from the storage unit and for adjusting a clock frequency of the clock signal generated by the clock generation unit to a clock frequency matched to the identified priority of the changed image when the identified priority is different from a priority of a previous image.

In one exemplary embodiment, the image display apparatus further includes an illumination sensor, and the controller may adjust the clock frequency of the clock signal generated by the clock generation unit based on the identified priority and an illumination level detected by the illumination sensor.

Other aspects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above and other aspects, features, and advantages of certain exemplary embodiments of the present invention will be more apparent from the following description taken in conjunction with the accompanying drawings, in which:

FIG. 1 is a block diagram illustrating an image display apparatus according to an exemplary embodiment of the present invention;

FIG. 2 is a flowchart diagram illustrating an image display method according to an exemplary embodiment of the present invention;

FIG. 3 is a view illustrating a priority table according to an exemplary embodiment of the present invention;

FIG. 4 is a flowchart diagram illustrating an image display method according to another exemplary embodiment of the present invention;

FIG. 5 is a flowchart diagram illustrating an image display method according to still another exemplary embodiment of the present invention; and

FIG. 6 is a view illustrating a priority table according to another exemplary embodiment of the present invention.

Throughout the drawings, it should be noted that like reference numbers are used to depict the same or similar elements, features, and structures.

### DETAILED DESCRIPTION OF EXEMPLARY EMBODIMENTS

The following description with reference to the accompanying drawings is provided to assist in a comprehensive understanding of exemplary embodiments of the invention as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the invention. In addition, descriptions of well-known functions and constructions may be omitted for clarity and conciseness.

The terms and words used in the following description and claims are not limited to the bibliographical meanings, are merely used by the inventor to enable a clear and consistent understanding of the invention. Accordingly, it should be apparent to those skilled in the art that the following description of exemplary embodiments of the present invention is provided for illustrative purposes only and not for the purpose of limiting the invention as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

Further, it should be noted that an image display apparatus of exemplary embodiments of the present invention can apply to any type of information and communication devices and multimedia devices, and application devices thereof, including, but not limited to, for example, a laptop Personal Computer (PC), a Portable Multimedia Player (PMP), a Personal Digital Assistant (PDA), a tablet PC, a mobile phone or a smart phone. More particularly, in the image display apparatus according to exemplary embodiments of the present invention, a clock frequency of an image is adjusted depending on user attention of the image. To this end, the image display apparatus sets a priority of each image, stores a matching clock frequency of the image determined based on the priority in a database, and, in a case where a display image is changed, a changed image is displayed at a clock frequency determined by referring to a corresponding priority of the changed image stored in the database. Hereinafter, for illustrative purposes, it is assumed that the image display apparatus is the smart phone.

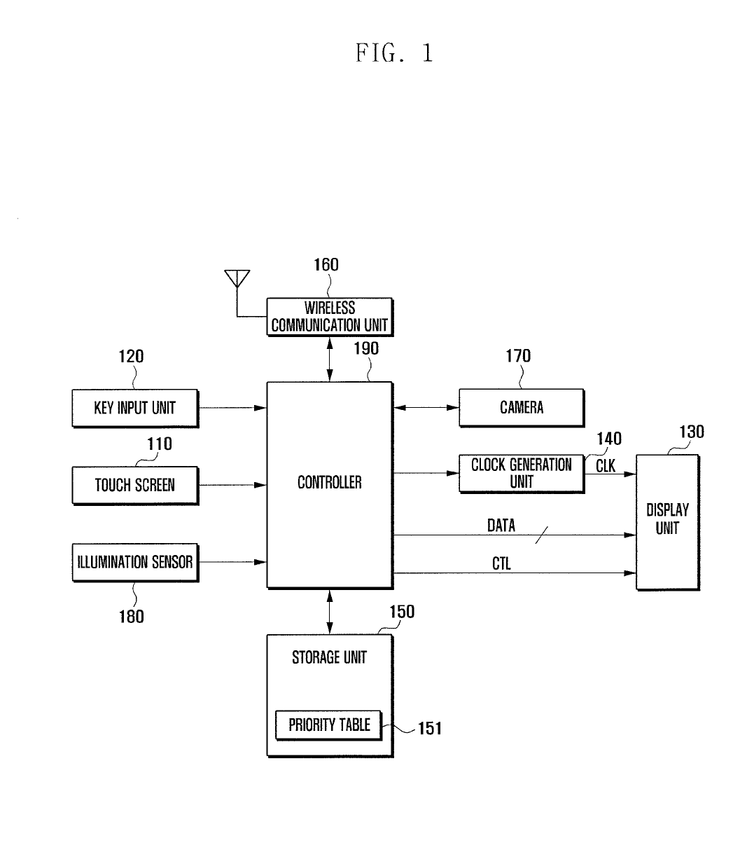

FIG. 1 is a block diagram illustrating an image display apparatus according to an exemplary embodiment of the present invention.

Referring to FIG. 1, the image display apparatus according to the exemplary embodiment of the present invention includes a touch screen 110, a key input unit 120, a display unit 130, a clock generation unit 140, a storage unit 150, a wireless communication unit 160, a camera 170, an illumination sensor 180, and a controller 190. According to other exemplary embodiments, the image display apparatus may include additional and/or different units. Similarly, the functionality of two or more of the above units could be integrated into a single component.

The touch screen 110 transmits a touch event to the controller 190. The touch event can include at least one of a touch and drop operation, a drag and drop operation, a flick and drop operation, etc. Here, the touch and drop operation refers to a gesture that touches a certain point on the touch screen 110 and then releases the touch. The drag and drop operation refers to a gesture that touches a certain point on the touch screen with a finger, moves the finger in a predetermined direction while maintaining the touch with the touch screen 110, and releases the touch. The flick and drop operation refers to a gesture that touches the touch screen 110 and releases the touch while simultaneously moving the finger that is in contact with the touch screen 110 at a higher speed. The controller 190 can distinguish the flick operation from the drag operation based on a speed at which the finger is moved. Also, the touch and drop operation can be divided into a tap operation and a press operation depending on a touch time. Namely, the tap operation is a gesture that touches the touch screen 110 for a brief time and releases the touch, and the press operation is a gesture that touches the touch screen 110 for a longer time and releases the touch. The touch event can be further characterized depending on, for example, a position, a direction, a distance or a pressure thereof Also, the touch screen 110 can be implemented by using at least one of a resistive type sensor, a capacitive type sensor, a pressure type sensor, etc.

The key input unit 120 includes a plurality of keys to manipulate an operation of the image display apparatus and transmits a key event to the controller 190. Here, the key event can include, for example, at least one of a power on/off event, a volume control event, a screen on/off event, etc.

The display unit 130 receives a control signal CTL and image data DATA from the controller 190. Here, the control signal can be, for example, at least one of a screen on signal, a screen off signal, a screen brightness control signal, etc. In addition, the display unit 130 can convert the image data DATA received from the controller 190 into an analog signal to be displayed. Also, the display unit 130, under the control of the controller 190, can display at least one of a video screen, an Internet screen, a camera screen, an application launch screen, a standby screen, an image item, a boot screen, a setup screen, an indicator screen, an audio player screen, a Frequency Modulation (FM) radio player screen, etc. Here, the standby screen can be a lock screen or a home screen. The lock screen is a screen typically displayed when a screen is turned on. The home screen is a screen that displays a plurality of icons for various applications. The boot screen is a screen that is displayed when the image display apparatus is booted. The setup screen is a screen used for setting various functions of the image display apparatus including, for example, at least one of Wireless-Fidelity (Wi-Fi) lock, sound control, brightness control, automatic lock, etc. The indicator screen is a screen that displays at least one of current time, battery life, reception quality, etc. The camera screen can display at least one of images captured by the camera 170, a video call screen received from the wireless communication unit 160, etc.

In addition, the display 130, under the control of the controller 190, can divide an entire screen area into at least one of an indicator area, a main area, etc. In addition, the display unit 130, under the control of the controller 190, can divide the entire screen into the indicator area, the main area and a sub area, display the indicator screen in the indicator area, and display a main screen and a sub screen in the main area and the sub area, respectively. Here, the main screen can include the at least one of the video screen, the Internet screen, the camera screen, the application launch screen, the standby screen, the image item, the boot screen, the setup screen, the indicator screen, the audio player screen, the FM radio player screen, etc. The sub screen can include at least one of an icon of an application being executed or a user's favorite application, a menu screen for editing or changing the main screen, the audio player screen, the FM radio player screen, etc.

The clock generation unit 140, under the control of the controller 190, generates a clock signal CLK for driving the display unit 130 and outputs the clock signal CLK to the display unit 130. Power consumption per hour of the display unit 130 is determined depending on a frequency of the clock signal CLK. For example, if the clock signal CLK has a frequency of 60 Hz, 50 Hz or 40 Hz, the power consumption of the display unit 130 is highest at the frequency of 60 Hz and lowest at the frequency of 40 Hz.

The storage unit 150 is configured to store programs and data needed to operate the image display apparatus. For example, the storage unit 150 can include at least one of an Operating System (OS), an application, data including an image, audio or video, etc. Also, the storage unit 150 may include a main storage unit and a secondary storage unit. Here, the secondary storage unit can include a flash memory and the main storage unit can include Random Access Memory (RAM). The main storage unit provides a space in which the operating system and the application are loaded. In other words, when the image display apparatus is booted, the operating system is loaded from the secondary storage unit to the main storage unit and is executed. Also, the application is loaded from the secondary storage unit to the main storage unit and is executed. When execution of a corresponding application is ended, the application is deleted from the main storage unit. Meanwhile, the secondary storage unit provides a space for storing the operating system, various applications and various data. Here, the secondary storage unit can include a data area and a program area. In particular, the data area according to an exemplary embodiment of the present invention is used to store a priority table 151. In the priority table 151, each image to be displayed is assigned a priority. Also, each priority has a clock frequency matched thereto. For example, a first priority is matched to a frequency of 60 Hz, a second priority is matched to a frequency of 50 Hz, and a third priority is matched to a frequency of 40 Hz. Also, in addition to the priority of the image, the priority table 151 can further include an illumination level measured by the illumination sensor 180 to be considered in determining the matching clock frequency of the image. For example, if an image is of the first priority and has an illumination level equal to or greater than a predefined threshold value, a clock frequency of 50 Hz can be matched with the image. On the other hand, if an image is of the first priority and has the illumination level lower than the predefined threshold value, a clock frequency of 60 Hz can be matched with the image.

The wireless communication unit 160 transmits and receives signals associated with at least one of mobile phone communication, Short Message Service (SMS), Multimedia Message Service (MMS), voice calls, video calls data communication, etc. In addition, the wireless communication unit 160 converts a data signal received from the controller 190 into an analog signal, converts the converted analog signal into a wireless signal, transmits the converted wireless signal via a communication network after power amplification, performs low noise amplification on the wireless signal received from the communication network, converts the low-noise amplified signal into an analog signal, and converts the converted analog signal into a data signal to output to the controller 190.

Also, the wireless communication unit 160 may include a short-range wireless communication module for connecting to a short range wireless communication network such as, for example, Wi-Fi wireless communication network, and a wide area wireless communication module for connecting to a wide area wireless communication network such as, for example, a 3^{rd} Generation (3G) or 4^{th} Generation (4G) wireless communication network.

The camera 170 is used to capture an image and converts an image signal into a data signal to be output to the controller 190. The camera 170 includes a front camera positioned on a front side of the image display apparatus and a rear camera positioned on a rear side thereof.

The illumination sensor 180 measures an ambient illumination of the image display apparatus and outputs the measured ambient illumination to the controller 190. Accordingly, the controller 190 can detect a change in the ambient illumination and control brightness of the image display apparatus accordingly.

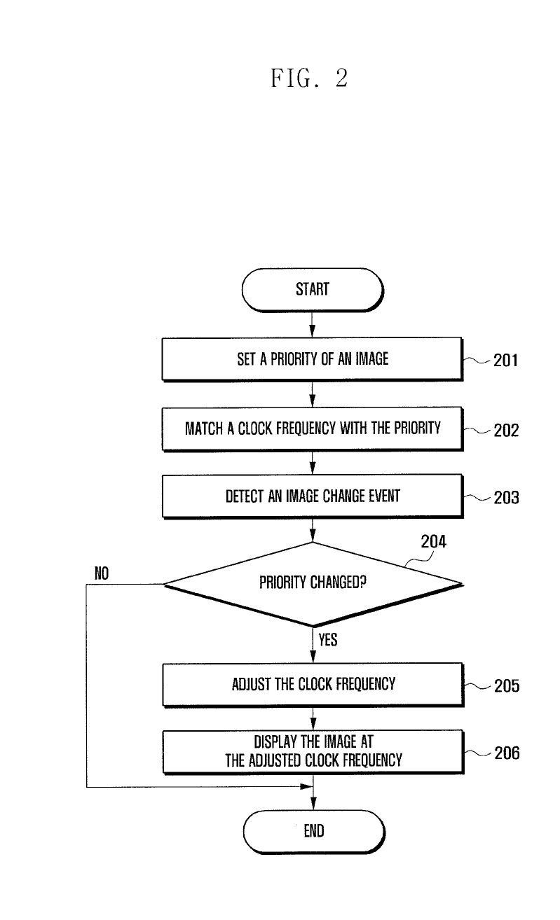

The controller 190 controls an overall operation of the image display apparatus and a signal flow between internal blocks of the image display apparatus. In particular, the controller 190 according to an exemplary embodiment of the present invention identifies the priority of the image data DATA transmitted to the display unit 130 from the priority table 151 and controls the clock generation unit 140 to generate the clock signal CLK having a clock frequency matched to the identified priority. Also, the controller 190 can detect a change in an external illumination and adjust the clock frequency accordingly. A method of displaying an image in which the clock frequency is modified by the controller 190 is described below with reference to FIGS. 2 to 6.

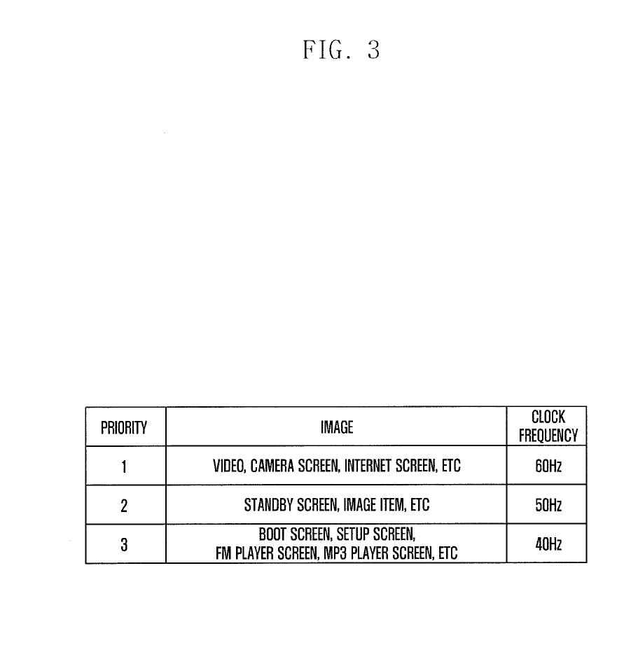

FIG. 2 is a flowchart diagram illustrating an image display method according to an exemplary embodiment of the present invention. FIG. 3 is a view illustrating a priority table according to an exemplary embodiment of the present invention;

Referring to FIGS. 2 and 3, the controller 190 sets the priority of images in step 201. For example, as shown in FIG. 3, the controller 190 assigns a first priority to an image with higher user attention such as, for example, a video screen, an internet screen or a camera screen. In addition, with respect to applications, the controller 190 assigns the first priority to an execution screen of an application with higher user attention such as, for example, a video call execution screen or a game execution screen. On the other hand, the controller 190 assigns a second priority to an image with a relatively lower user attention such as, for example, the standby screen or image items. Other images having the relatively lowest user attention such as the boot screen or the setup screen are set to a third priority. In addition, with respect to the applications, the controller 190 assigns the third priority to an execution screen of an application with a lower user attention such as, for example, the audio player screen, the FM radio player screen, or a screen displayed when a voice call is connected. Next, the controller 190 matches the clock frequency with each priority in step 202. Specifically, as illustrated in FIG. 3, the controller 190 can, for example, match a highest frequency of 60 Hz to a first priority image, match a second highest frequency of 50 Hz to a second priority image, and match a lowest frequency of 40 Hz to a third priority image. Next, the controller 190 controls the clock generation unit 140 based on the priority table shown in FIG. 3.

Next, when an image change event is detected in step 203, the controller 190 proceeds to step 204. The controller 190 determines whether the priority is changed in step 204. Here, the image change event can be a touch event or a key event. For example, the touch event or the key event that requires a change in a display image can be an event of driving the camera 170, placing a voice or a video call, or running an application. In addition, the image change event can be an external event in which an image is sent from the wireless communication unit 160 to the controller 190. For example, the external event that requires a change in the display image can be a call receiving event or a message receiving event. Also, when the screen is divided into several areas, the controller 190 can consider only the image change event occurring in a predetermined area, for example, the main area. In other words, in a process of varying the clock frequency, a screen change in the indicator area or the sub area may not be considered.

When it is determined that the priority of a changed image is different from the priority of a previous image at step 204, the controller 190 proceeds to step 205. On the other hand, when the priority of the changed image is identical with the priority of the previous image, the process of varying the clock frequency is terminated. The controller 190 modifies a currently set clock frequency to a clock frequency matched to the changed image in step 205 and proceeds to step 206. Specifically, when the changed image has a higher priority than the previous image, the controller 190 adjusts the clock frequency to be higher. On the other hand, when the changed image has a lower priority, the clock frequency is adjusted to be lower. The controller 190 controls the clock generation unit 140 such that the image is displayed at the adjusted clock frequency in step 206.

Meanwhile, the controller 190 can control power consumption of the display unit 130 by varying the clock frequency according to a change in the illumination level. For example, when the image display apparatus is in a bright environment, the controller 190 can set the clock frequency to be lower instead of increasing screen brightness. On the other hand, when the image display apparatus is in a relatively dark environment, the controller 190 can set the clock frequency to be higher instead of lowering the screen brightness. In addition, when multiple images need to be displayed through the display unit 160, the controller 190 can identify the priority of each of the multiple images from the priority table and control the clock generation unit 140 to display the multiple images at a clock frequency matched to a highest priority among the identified priorities.

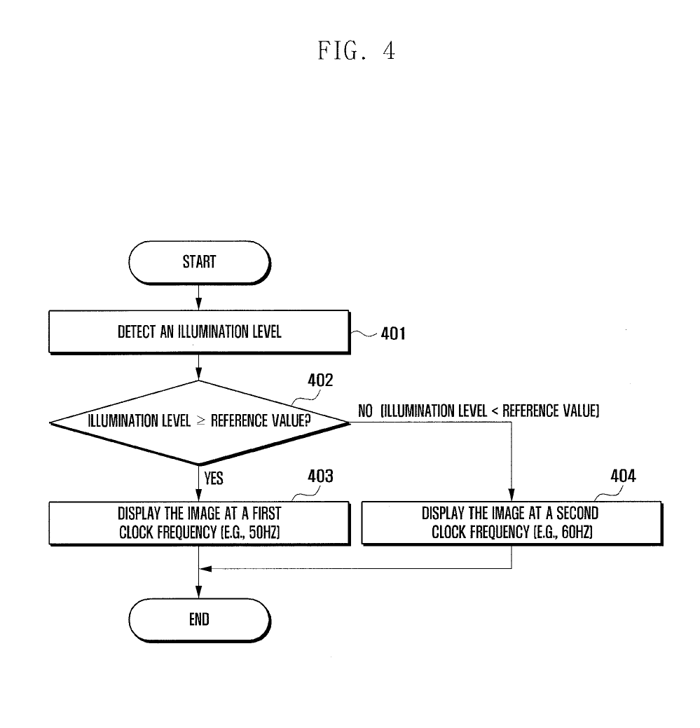

FIG. 4 is a flowchart diagram illustrating an image display method according to another exemplary embodiment of the present invention.

Referring to FIG. 4, the controller 190 detects the illumination level in step 401. Next, the controller 190 determines whether the detected illumination level is equal to or greater than a preset reference value in step 402. When it is determined in step 402 that the detected illumination level is equal to or greater than the reference value, the controller 190 proceeds to step 403. The controller 190 controls the clock generation unit 140 such that the image is displayed at a first clock frequency, e.g., 50 Hz, in step 403. On the other hand, when it is determined that the detected illumination level is less than the reference value in step 402, the controller 190 proceeds to step 404. The controller 190 controls the clock generation unit 140 such that the image is displayed at a second clock frequency, e.g., 60 Hz, in step 404. According to the exemplary embodiment of FIG. 4, the clock frequency is varied by using one reference value. However, it should be noted that the present invention is not limited to this example and two or more reference values can be used to vary the clock frequency.

Meanwhile, the controller 190 can control the power consumption of the image display apparatus by varying the clock frequency based on the priority of the changed image and the detected illumination level.

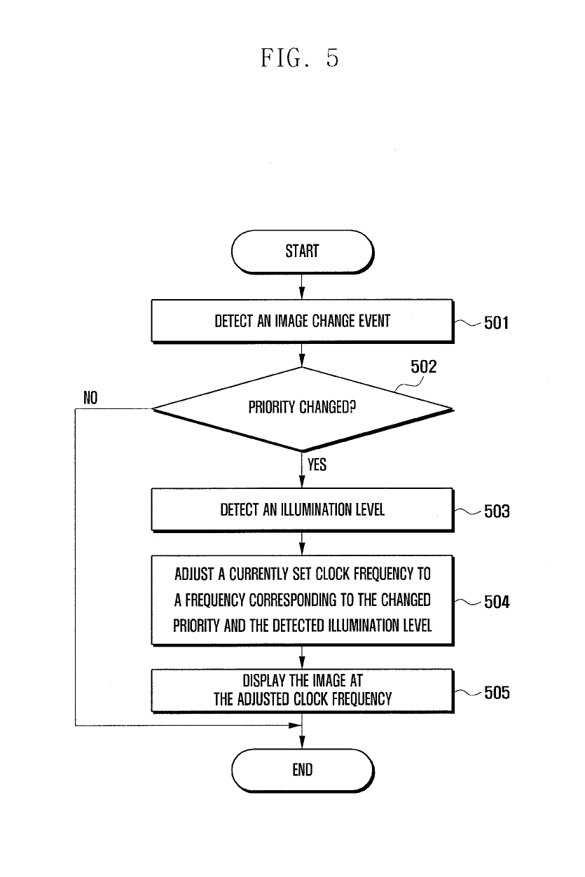

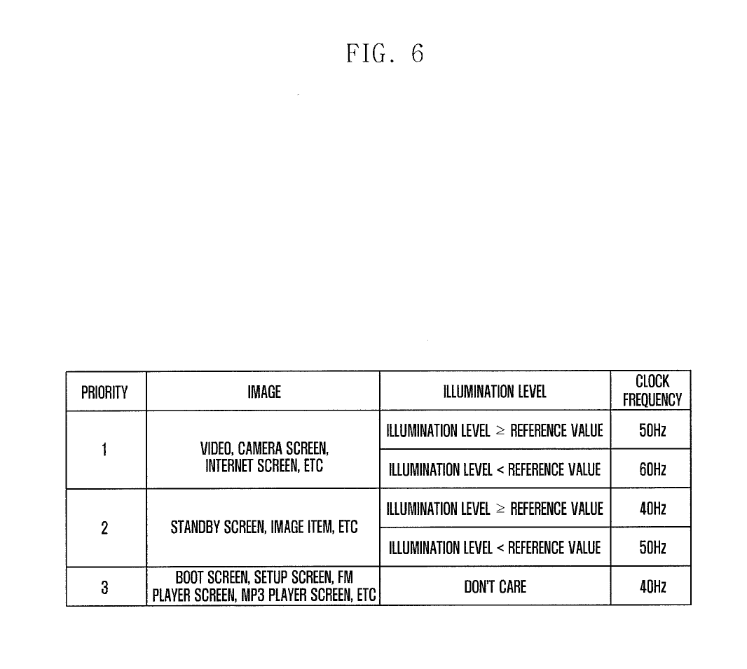

FIG. 5 is a flowchart diagram illustrating an image display method according to still another exemplary embodiment of the present invention. FIG. 6 is a view illustrating a priority table according to another exemplary embodiment of the present invention.

Referring to FIGS. 5 and 6, when the image change event is detected in step 501, the controller 190 proceeds to step 502. The controller 190 determines whether the priority of the changed image is different from the priority of the previous image by referring to the priority table shown in FIG. 6 in step 502. When it is determined that the priority of the changed image is different from the priority of the previous image, for example, in a case in which the previous image is a standby screen having the second priority and the changed image is the Internet screen having the first priority, the controller 190 proceeds to step 503. On the other hand, when the priority of the changed image is identical with the priority of the previous image, for example, in a case in which the standby screen is changed to the image item, the controller 190 terminates the process of varying the clock frequency. In other words, the controller 190 maintains a current clock frequency. The controller 190 detects the illumination level in step 503 and proceeds to step 504. Here, step 503 may be omitted. Namely, the controller 190 can periodically detect the illumination level independently of the process of varying the clock frequency.

The controller 190 modifies the currently set clock frequency to a clock frequency corresponding to the priority of the changed image and the detected illumination level in step 504. For example, referring to FIG. 6, when the detected illumination level is less than the reference value and the image having the first priority is changed to the image item having the second priority, the controller 190 modifies the clock frequency from 60 Hz to 50 Hz. Next, the controller 190 controls the clock generation unit 140 such that the image is displayed at a modified clock frequency in step 505. Meanwhile, when the detected illumination level is equal to or greater than the reference value and the image having the second priority is changed to the image having the third priority, the controller 190 can maintain at the currently set clock frequency, e.g., 40 Hz, as shown in FIG. 6.

As described above, according to exemplary embodiments of the present invention, a clock frequency is adjusted based on at least one of priority of each image that is determined on user attention and a detected illumination level so that power consumption of a display apparatus and a load on a Central Processing Unit (CPU) as well as heat generation can be reduced

While the invention has been shown and described with reference to certain exemplary embodiments thereof, it will be understood by those skilled in the art that various changes in form and details may be made therein without departing from the spirit and scope of the invention as defined by the appended claims and their equivalents.

What is claimed is:

1. An image display method, the method comprising:
identifying a priority of an image from a database to set a clock frequency of the image;
adjusting a currently set clock frequency to a clock frequency matched to the identified priority; and
displaying the image at the adjusted clock frequency.

2. The method according to claim 1, further comprising:
setting the priority of images; and
matching different clock frequencies to each priority and storing the matched clock frequencies in the database.

3. The method according to claim 2, wherein the priority of each image is set according to a corresponding user attention of the respective image.

4. The method according to claim 2, wherein the storing of the matched clock frequencies comprises:
matching a higher clock frequency to a higher priority and storing the matched clock frequency.

5. The method according to claim 4, wherein the setting of the priority of the images comprises:
setting a first priority to at least one of a video screen, a camera screen, and an Internet screen;
setting a second priority to at least one of a standby screen and an image item; and
setting a third priority to at least one of a boot screen, a setup screen, a Frequency Modulation (FM) radio player screen, and an audio player screen.

6. The method according to claim 5, wherein the matching of the different clock frequencies comprises:
matching a clock frequency of 60 Hz to the first priority;
matching a clock frequency of 50 Hz to the second priority; and
matching a clock frequency of 40 Hz to the third priority.

7. The method according to claim 1, further comprising:
detecting an illumination level, wherein the adjusting comprises:
adjusting the currently set clock frequency based on the identified priority and the detected illumination level.

8. The method according to claim 7, wherein the adjusting comprises:
adjusting the clock frequency to be lower than the currently set clock frequency when the detected illumination level is equal to or greater than a preset reference value.

9. The method according to claim 1, wherein the identifying comprises:
identifying, when a screen is divided into a plurality of areas and an image change event is detected in a particular area that is predetermined among the plurality of the areas, a priority of a changed image in the particular area from the database.

10. The method according to claim 9, wherein the image change event comprises at least one of a touch event, a key event, a camera driving event, a voice call transmitting or receiving event, a video call transmitting or receiving event, a message transmitting or receiving event, and an application execution event.

11. The method according to claim 1, wherein the identifying comprises:
identifying, when an image change event is detected, the priority of a changed image from the database.

12. The method according to claim 11, wherein the image change event comprises at least one of a touch event, a key event, a camera driving event, a voice call transmitting or receiving event, a video call transmitting or receiving event, a message transmitting or receiving event, and an application execution event.

13. The method according to claim 1, wherein the displaying comprises:
identifying a priority of each of a plurality of images from the database; and
displaying the plurality of the images at a clock frequency matched to a priority highest among the identified priority.

14. An image display apparatus, the apparatus comprising:
a clock generation unit for generating a clock signal;
a display unit for displaying an image by using the clock signal received from the clock generation unit;
a storage unit for storing a priority set to each image and different clock frequencies matched to each priority; and
a controller for, when the image is changed, identifying a priority of a changed image from the storage unit and for adjusting a clock frequency of the clock signal generated by the clock generation unit to a clock frequency matched to the identified priority of the changed image when the identified priority is different from a priority of a previous image.

15. The apparatus according to claim 14, further comprising:
an illumination sensor, wherein the controller is configured to adjust the clock frequency of the clock signal generated by the clock generation unit based on the identified priority and an illumination level detected by the illumination sensor.

16. The apparatus according to claim 14, wherein the image is changed as a result of at least one of a touch event, a key event, a camera driving event, a voice call transmitting or receiving event, a video call transmitting or receiving event, a message transmitting or receiving event, and an application execution event.

17. The apparatus according to claim 14, wherein the higher the priority, the higher the clock frequency.

18. The apparatus according to claim 14, wherein the display unit displays a plurality of images, and wherein one of more of the plurality of images is displayed using a clock frequency matched to a respective priority of the one of more of the plurality of images.
